(19) United States
(12) Patent Application Publication
(10) Pub. No.: US 2006/0250219 A1
(43) Pub. Date: Nov. 9, 2006

(54) PERSONAL AREA DIGITAL ASSET MANAGEMENT SYSTEM

(76) Inventor: Zhou Hui, Foster City, CA (US)

Correspondence Address: Michael T. Konczal;Patent Attorney, P.O. Box 863656, Plano, TX, 75086, US

(21) Appl. No.: 11/380,414

(22) Filed: Apr. 26, 2006

Related U.S. Application Data
(60) Provisional application No. 60/678,164, filed on May 6, 2005.

(51) Int. Cl. H04Q 5/22

(52) U.S. Cl. 340/10.1; 340/539.1

(57) ABSTRACT

A wireless electronic tracking system is disclosed in which a host apparatus contains an integral monitoring device capable of using power and/or timer, and/or user interface functions of the host apparatus. The monitoring device is further adapted for wirelessly tracking one or more tags deployed with a certain proximity. The monitoring device uses a wireless transceiver programmed for periodically instigating a tag to send a signal, monitoring received tag signals, and indicating to a user the identity of unresponsive tags.

### PRIORITY

This application is entitled to the priority date of May 06, 2005, based on Provisional Patent Application Number 60/678,164 filed with the USPTO on that date.

### TECHNICAL FIELD

The invention relates to electronic tracking and communication between and among portable electronic devices. More particularly, the invention relates to the electronic tracking of physical assets within a certain proximity of a monitoring device.

### BACKGROUND OF THE INVENTION

There has always been a need for tools to help people manage personal assets, especially for travelers and professionals encumbered with multiple electronic devices or other valuable portable property. One important aspect of this management is preventing the loss or theft of valuable items. Personal asset management increases in importance as the asset value increases. Portable electronic devices and other items carried by travelers are often expensive, highly customized, or personal, warranting a high degree of protection from loss or theft. Due to these and other problems, it would be useful and advantageous to provide improved tracking systems for managing personal physical assets within a selected proximity of the user.

### SUMMARY OF THE INVENTION

In carrying out the principles of the present invention, in accordance with preferred embodiments thereof, one or more remotely readable tags are wirelessly linked to a monitoring device for tracking in accordance with programmable preferences.

According to one aspect of the invention, at least one deployable tag is operably linked to a monitoring device using software of the invention for controlling tracking parameters and preferences.

According to another aspect of the invention, a Bluetooth-enabled monitoring device is used to facilitate tracking. Bluetooth® is a trademark of Bluetooth WIG Incorporated, of Bellevue, Washington, USA.

According to yet another aspect of the invention, one or more Bluetooth-enabled tag devices include a Bluetooth chip and certain embedded software.

According to another aspect of the invention, one or more tag devices are integrated into one or more apparatus adapted for compatibility with the system of the invention.

According to another aspect of the invention, one or more tag devices are integrated into one or more items of portable property, such as for example, a wallet or article of luggage.

According to still another aspect of the invention, in an exemplary preferred embodiment, a wireless electronic tracking system includes a monitoring device integrated with a host apparatus. The monitoring device is configured for using one or more of the power, timer, and/or user interface functions of the host apparatus. The system also includes one or more deployable tags adapted for signaling the monitoring device. The monitoring device is equipped for tracking the proximity of the one or more tags, using a wireless transceiver programmed for periodically instigating a tag to send a signal to the wireless transceiver, and for monitoring received tag signals, indicating unresponsive tags using a display, alarm, or other user interface provided by the host apparatus as the need arises.

The invention has advantages including but not limited to facilitating wireless tracking of physical assets. This and other features, advantages, and benefits of the present invention can be understood by one of ordinary skill in the arts upon careful consideration of the detailed description of representative embodiments of the invention in connection with the accompanying drawings.

### BRIEF DESCRIPTION OF THE DRAWINGS

The present invention will be more clearly understood from consideration of the following detailed description and drawings in which:

FIG. 1 is a simplified block diagram providing an overview of an example of a system embodying the invention; and

FIG. 2 is a simplified process flow diagram illustrating examples of the operation of preferred embodiments of the invention.

References in the detailed description correspond to like references in the various drawings unless otherwise noted. Descriptive and directional terms used in the written description such as first, second, top, bottom, upper, side, etc., refer to the drawings themselves as laid out on the paper and not to physical limitations of the invention unless specifically noted. The drawings are not to scale, and some features of embodiments shown and discussed are simplified or amplified for illustrating the principles, features, and advantages of the invention.

### DESCRIPTION OF PREFERRED EMBODIMENTS

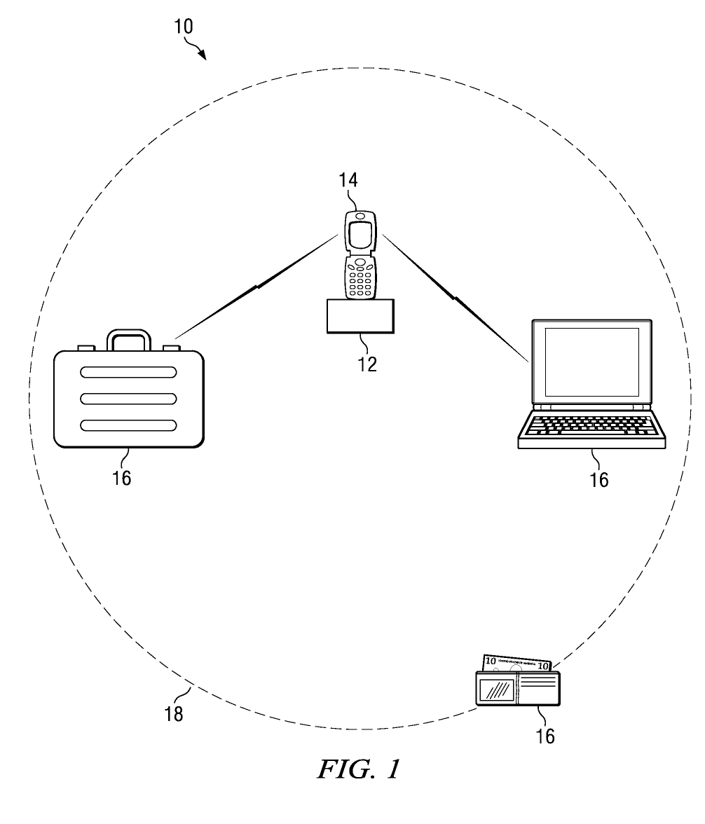

In general, the invention utilizes programmable wireless transceiver modules to create a three-dimensional secure personal area about 10-100 meters in radius, depending on the implementation chosen and the conditions and obstructions present in the surroundings. The invention preferably includes one or more tag devices, and a monitoring device, which is preferably implemented in the form of monitoring software in a suitable host apparatus as further described. Any associated tag device can be tracked within this effective range. Tracking is preferably monitored by the monitoring device, which is preferably integrated within a host apparatus. The host apparatus provides infrastructure for the systems such as power supply, a user interface mechanism, and a timer. The host apparatus may include, for example, a Bluetooth-enabled cellular telephone, PDA (Personal Digital Assistant), smart phone, laptop computer, or other electronic apparatus. Preferably, if a tagged item goes out of the proximity for whatever reason, an alarm is triggered by the monitoring device and the user interface function(s) of the host apparatus is used to alert the user. The user interface may include, for example, one or more of the following: visual monitors such as LCD or plasma displays; audible signals; or mechanical vibration signals. FIG. 1 depicts an overview of the components of a system 10 embodying the invention. A monitoring device 12 residing in host apparatus 14 is capable of monitoring tags 16 located within a certain proximity 18, which may encompass an area approximately 10 to 100 meters in radius, or closer, with the monitoring device 12 at the center. Software capabilities are preferably provided in the monitoring device 12 and/or tag device(s) 16 for managing monitoring features within the capabilities of the particular monitoring device 12 and tag(s) 16 of the system 10. It should be appreciated by those skilled in the arts that the monitoring device 12 is preferably implemented as a set of software instructions residing with the host apparatus 14.

Preferably, a generic or “universal” tag 16 is used that may be customized to some extent by the user. The preferred embodiment uses a tag 16 with an electronic circuit including a wireless transceiver, such as a Bluetooth chip, and certain embedded software. In the preferred embodiments of the invention, a small battery or other portable current source powers the tag 16, which may be packaged into any suitable shape or form, including a stand-alone device for attachment to any object by the user, and/or as an embedded device integrated within objects such as, for example, portable electronics, wallets, handbags, and luggage. The software included in the tag 16 itself is preferably minimal and most of the functionality of the system 10 is provided in the monitoring device 12. For compatibility with Bluetooth implementation, the tag 16 preferably includes a L2CAP (Logical Link Control and Adaptation Protocol) layer and control functions as needed. In order to preserve battery power for the tag 16, it is preferred to configure the tag 16 to operate in inquiry scan mode for a very short time, e.g. two minutes, when the tag 16 powers on. There are currently three alternative preferred embodiments for implementation of this tag 16. The first is in the form of an ASIC (Application Specific Integrated Circuit) module, which integrates application software on the same microprocessor platform with the Bluetooth firmware. A second alternative embodiment is a highly integrated Bluetooth chip solution, such as for example, the BlueCore™ family of chips, available from Cambridge Silicon Radio, Cambridge UK, which permit the application software to run in a controlled virtual machine environment on the same microprocessor as Bluetooth lower stack. BlueCore is a trademark of Cambridge Silicon Radio Limited Corporation, United Kingdom. The third alternative tag implementation is a dual microprocessor solution where application software runs on a processor separate from the Bluetooth chip. In this setting, the lower stack of the Bluetooth chip implements a HCI (Host Controller Interface) and the application software communicates with the HCI through a physical transportation layer, such as UART (Universal Asynchronous Receive Transmit), USB (Universal Serial Bus) or RS232.

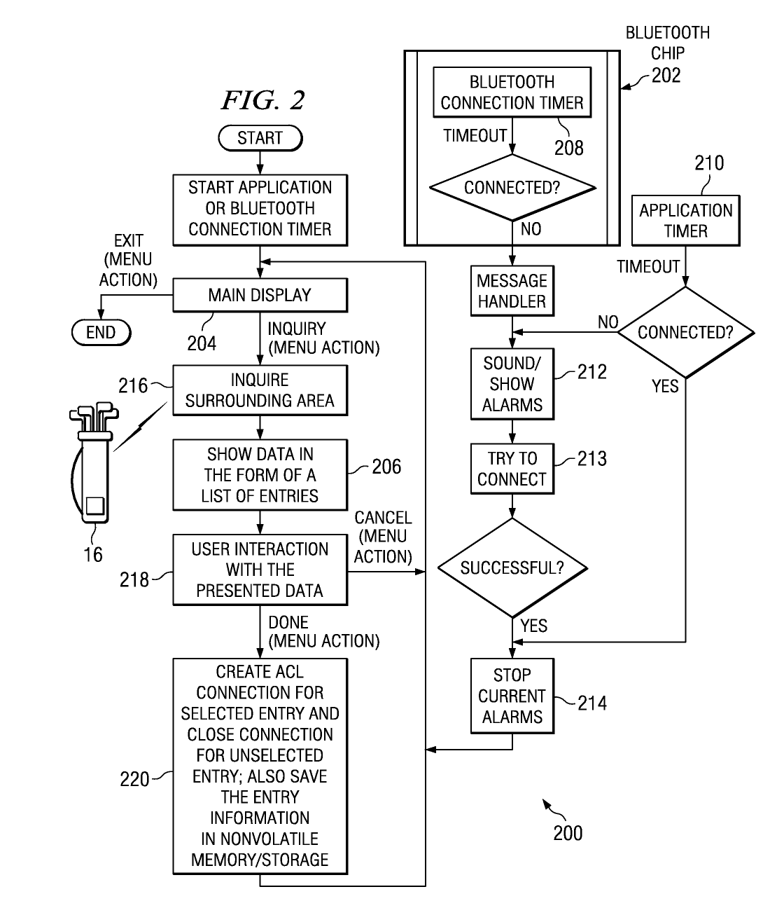

The monitoring device 12 includes a software application referred to herein as Personal Area Digital Asset Manager (PADAM) adapted to function with consumer electronics platforms such as Bluetooth-enabled portable electronic apparatus such as, for example, cellular telephones. This PADAM application software may be implemented in various ways on different cellular phone platforms and environments consistent with the principles of the invention, provided that they are adapted to perform essentially the same tracking and alarm functions. FIG. 2 is a combined process flow and state diagram of the preferred modules of the PADAM system 200 and the principles of their operation. For example, the system 200 may be a high level user application using Bluetooth API provided by an operating system, or may be implemented as an embedded application with direct access to Bluetooth lower level stack. The PADAM 200 system according to the invention may be implemented by pre-installing in the host apparatus by the manufacturer, or may be downloaded and installed by end users. Preferably, a main display 204 is adapted for reading stored user-selected information from a non-volatile memory/storage and displaying them on a screen such as a Liquid Crystal Display (LCD). The displayed data 206 preferably includes a list of entries representing previously selected remote Bluetooth devices, or tags 16, for monitoring. Each entry may contain the tag address, a user-friendly description or name of the tag device, and an alert sound, visual display signal, or mechanical vibration alarm signal selected for that particular tag.

A Bluetooth connection timer 208 preferably uses the built-in Link Manager (LM) supervision timer typically included in Bluetooth chips to check the status of the connection, set a selected timeout value, and wait for asynchronous notification from the LM/HCI (Host Controller Interface) of the occurrence of a disconnection. An application timer 210 may be used and its timeout value may be user selectable. Preferably, at every timeout, link connection status is verified for each monitored entry, e.g., for each active tag 16. A “sound/show alarms” function 212 responsive to the link status for each tag 16 preferably highlights the displayed entry associated with the particular tag 16 in the form of coloring or highlighting the display element or text description, and activates the selected or default audible or visible alarm at the monitoring device 12 or the associated host apparatus 14. Subsequently, a “try to connect” 213 function is preferably implemented in order to attempt to establish or reestablish the ACL connection. A “stop current alarms” 214 function is preferably provided for stopping the alarm and showing monitored devices 16 in a “normal” state, e.g., active and present within the selected proximity 18.

Inquiry mode 216 is provided in order to check for Bluetooth-enabled devices, e.g. tags 16, in the proximity 18. The result is preferably a displayed (204) list which includes remote tags 16 responsive to the inquiry 216. User interaction with the displayed 204 data makes use of the list from the inquiry operation 216, which is preferably parsed to extract address, name, class of device, etc. The resulting data is presented in the user interface 218 as a list of entries for remote tags 16. Users may then select any number of entries/tags to track or deselect entries to remove the tracking link from previous selections. Preferably, users may select the option to edit the name field of the entry if there is none from inquiry for that tag 16. Users may also preferably be given the option to select preset or customized alerts for each of the tracked tags 16. As shown at box 220, a function “create ACL connection” may be used for one or more selected entries and “close ACL connection” for deselecting a previously connected entry. Also, the system preferably may include the capacity to save entry information in nonvolatile memory. The information saved may then be made available to be read by the main display module 204 subsequently.

The methods and apparatus of the invention provide one or more advantages including but not limited to assisting with the management of physical assets within a given proximity. While the invention has been described with reference to certain illustrative embodiments, those described herein are not intended to be construed in a limiting sense. For example, the system of the invention provides a framework in which a user may program additional features in particular cases without departure from the invention. Various modifications and combinations of the illustrative embodiments as well as other advantages and embodiments of the invention will be apparent to persons skilled in the arts upon reference to the drawings, description, and claims.

I claim:

1. A wireless electronic tracking system comprising:
a host apparatus further comprising a monitoring device configured for using power, timer, and user interface functions of the host apparatus;
one or more deployable tags adapted for signaling the monitoring device;
a monitoring device adapted for wirelessly tracking the proximity of the one or more tags, the monitoring device further comprising;
a wireless transceiver programmed for periodically instigating a tag to send a signal to the wireless transceiver, the wireless transceiver also programmed for monitoring received tag signals and for indicating unresponsive tags using the host apparatus user interface.

2. A wireless electronic tracking system according to claim 1 wherein the wireless transceiver further comprises a Bluetooth module.

3. A wireless electronic tracking system according to claim 1 wherein the host apparatus further comprises a wireless telephone.

4. A wireless electronic tracking system according to claim 1 wherein the host apparatus further comprises a personal digital assistant.

5. A wireless electronic tracking system according to claim 1 wherein the host apparatus further comprises a personal computer.

6. A wireless electronic tracking system according to claim 1 wherein the host apparatus further comprises a portable computer.

7. A wireless electronic tracking system according to claim 1 wherein the user interface further comprises a visual image.

8. A wireless electronic tracking system according to claim 1 wherein the user interface further comprises a text message.

9. A wireless electronic tracking system according to claim 1 wherein the user interface further comprises an audible alarm.

10. A wireless electronic tracking system according to claim 1 wherein the user interface further comprises a mechanical vibration alarm.

11. A wireless electronic tracking system according to claim 1 wherein the tag further comprises a Bluetooth module.

12. A wireless electronic tracking system according to claim 1 wherein the tag further comprises an ASIC module.

13. A wireless electronic tracking system according to claim 1 wherein the tag further comprises a L2CAP capability.
